(19) United States
(12) Patent Application Publication
(10) Pub. No.: US 2009/0187442 A1
(43) Pub. Date: Jul. 23, 2009

(54) FEEDBACK AUGMENTED OBJECT REPUTATION SERVICE

(75) Inventors: Gregory KOHANIM, Issaquah, WA (US); Elliot Jeb HABER, Fall City, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/018,199

(22) Filed: Jan. 23, 2008

(51) Int. Cl. G06Q 99/00; G06Q 10/00; G06F 15/16

(52) U.S. Cl. 705/7; 705/1; 709/203

(57) ABSTRACT

Described herein is technology for, among other things, implementing a feedback augmented optic reputation service. A request for an object reputation is received from a user, and in response to the request, a reputation generation service is accessed to determine a value for the object reputation. The value for the object reputation is returned to the user. Feedback is solicited from the user when displaying information regarding the object reputation. Feedback regarding the returned object reputation is received from the user, and a knowledge base describing the object reputation is updated in consideration of the feedback. An updated object reputation is returned in response to a subsequent request.

### BACKGROUND

An increased number of transactions of all types (e.g., financial, social, educational, religious, entertainment, etc.) are taking place in the virtual environment of the Internet rather than in the real world environment. The parties participating in a virtual environment transaction are more likely to be separated by some unknown distance and are more likely not to have the opportunity to visually see each other during the transaction compared to parties participating in a real world environment transaction.

As a consequence, the virtual environment transactions have been compromised by fraudulent practices that lead to property, identity, and personal information theft and lead to abuse and bodily injury. Some examples of these fraudulent practices include phishing, spy ware, and predatory behavior. Phishing refers to the acquisition of personal information (e.g., usernames, passwords, social security number, credit card information, bank account details, etc.) from a person in an illegitimate manner (e.g., through e-mails, instant messages, and/or websites from impersonated parties) for criminal purposes. Spy ware refers to damaging, privacy infiltrating, threatening, or malicious software. Usually, spy ware invades a person's computer resources without the person's knowledge. Predatory behavior refers to activity of persons or businesses intending to defraud, harm, or harass others by taking advantage of the anonymous nature of virtual environment transactions.

Given the problems of virtual environment transactions, several solutions have been crafted to deal with these problems. Although these solutions have had various degrees of success in mitigating the fraudulent practices, the losses attributable to the fraudulent practices continue to rise due to the tremendous growth in the number of virtual environment transactions.

Deficiencies in measures implemented to deal with the phishing types of malware are illustrative of shortcomings of actions taken to address other fraudulent practices plaguing virtual environment transactions. Typically, a heuristic methodology is utilized in anti-phishing tools. To determine whether a website being accessed is a phishing website, the heuristic methodology examines various characteristics and attributes of the website to classify the website as either a non-phishing website or a phishing website to which access is blocked. Due to accuracy limitations of the heuristic methodology, the false positive rate (or rate that a website is classified as a phishing website when the website is actually a non-phishing website) may be higher than desired. This frustrates visitors to the incorrectly classified website and causes the owners of the incorrectly classified website to raise legal issues. Frustrated visitors may be inclined to turn-off the anti-phishing tool, increasing their vulnerability to phishing. In a greater portion of the visited websites than desired, the heuristic methodology may not be able to actually classify websites as non-phishing or phishing, prompting a caution message to the visitor alerting to the possibility of phishing. The caution message may appear so frequently that it may simply be ignored instead of being seriously considered.

Moreover, the heuristic methodology is susceptible to reverse engineering by individuals intending to continue phishing activity undetectable by the heuristic methodology. This influences the false negative rate (or rate that a website is classified as a non-phishing website when the website is actually a phishing website). Furthermore, the heuristic methodology is typically applied only to visited websites. Non-visited websites are not subjected to the heuristic methodology to classify the websites as either non-phishing websites or phishing websites to which access is blocked, limiting the scope of protection against phishing.

These identified deficiencies also hinder obtaining useful feedback from visitors to websites and actually discourage visitors from providing feedback that may help correct or improve anti-phishing tools.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Embodiments of the claimed subject matter, among other things, involve the soliciting of user feedback concerning the reputation of objects to implement a feedback augmented object reputation service. It is desired to obtain user feedback based on the object's reputation rather than heuristics. A particular object may be one of a number of different types of objects. URLs (Uniform Resource Locators), software, persons, and businesses are examples of types of objects. Various data sources are used to determine the reputation. The reputations of the objects are made available upon request, such as via a reputation service. Web clients may request object reputations from the reputation service. Those objects having a reputation that is not sufficient to label them “safe” can, with adequate certainty, trigger a feedback solicitation process, for example, implemented through the functionality of the user's Web browser (e.g., solicitation dialogue, etc.). The solicitation process solicits specific user feedback concerning the object, and involves the user indicating whether the object is either a dangerous object (e.g., phishing, spy ware, etc.) or a safe object. The feedback is used to update a knowledge base describing the object reputation. In response to any subsequent requests, the updated object reputation is returned.

Thus, embodiments provide a targeted manner of soliciting feedback from the user community to categorize an object's reputation and increase the accuracy of reputation characterizations returned for subsequent queries. The targeted manner of soliciting feedback increases participation by the user community. Moreover, the targeted manner of soliciting feedback is well suited to deal with various undesirable practices such as phishing, spy ware, and predatory behavior.

### BRIEF DESCRIPTION OF THE DRAWINGS

The present invention is illustrated by way of example, and not by way of limitation, in the figures of the accompanying drawings and in which like reference numerals refer to similar elements.

FIG. 1 shows a diagram of an exemplary system for a feedback augmented object reputation service in accordance with one embodiment.

FIG. 2 shows a flowchart of the steps of a feedback augmented object reputation process in accordance with one embodiment.

FIG. 3 shows a diagram of internal components of a reputation generation service in accordance one embodiment.

FIG. 4 shows an exemplary user feedback prompt dialog in accordance with one embodiment.

FIG. 5 shows an exemplary computer system according to one embodiment.

### DETAILED DESCRIPTION

Reference will now be made in detail to embodiments of the claimed subject matter, examples of which are illustrated in the accompanying drawings. While the embodiments will be described, it will be understood that the descriptions are not intended to limit the claimed subject matter to these embodiments. On the contrary, the claimed subject matter is intended to cover alternatives, modifications and equivalents, which may be included within the spirit and scope as defined by the appended claims. Furthermore, in the following detailed description, numerous specific details are set forth in order to provide a thorough understanding of the embodiments. However, it will be recognized by one of ordinary skill in the art that the embodiments may be practiced without these specific details. In other instances, well-known methods, procedures, components, and circuits have not been described in detail as not to unnecessarily obscure aspects of the embodiments.

Some portions of the detailed descriptions are presented in terms of procedures, steps, logic blocks, processing, and other symbolic representations of operations on data bits within a computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

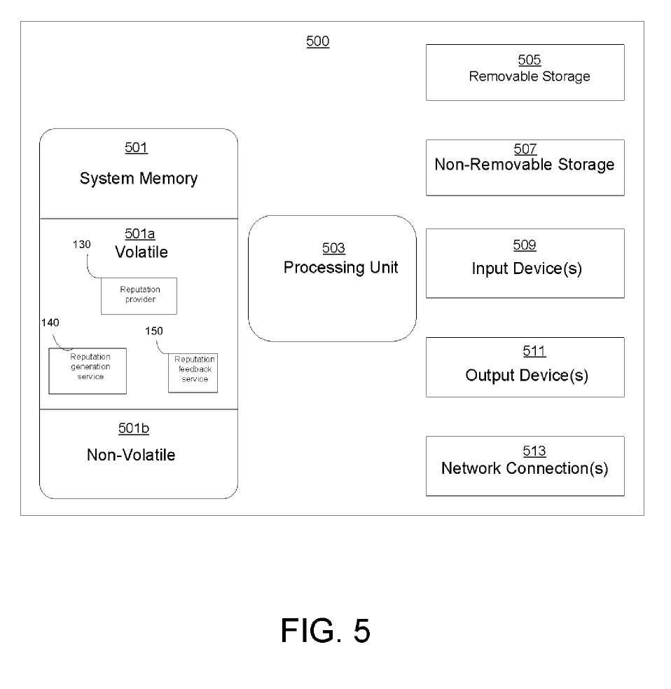

It should be borne in mind, however, that these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “accessing” or “tagging” or “characterizing” or “filtering” or the like, refer to the action and processes of a computer system (e.g., computer system 500 of FIG. 5), or similar electronic computing device, that manipulates and transforms data represented as physical (electronic) quantities within the computer system's registers and memories into other data similarly represented as physical quantities within the computer system memories or registers or other such information storage, transmission or display devices.

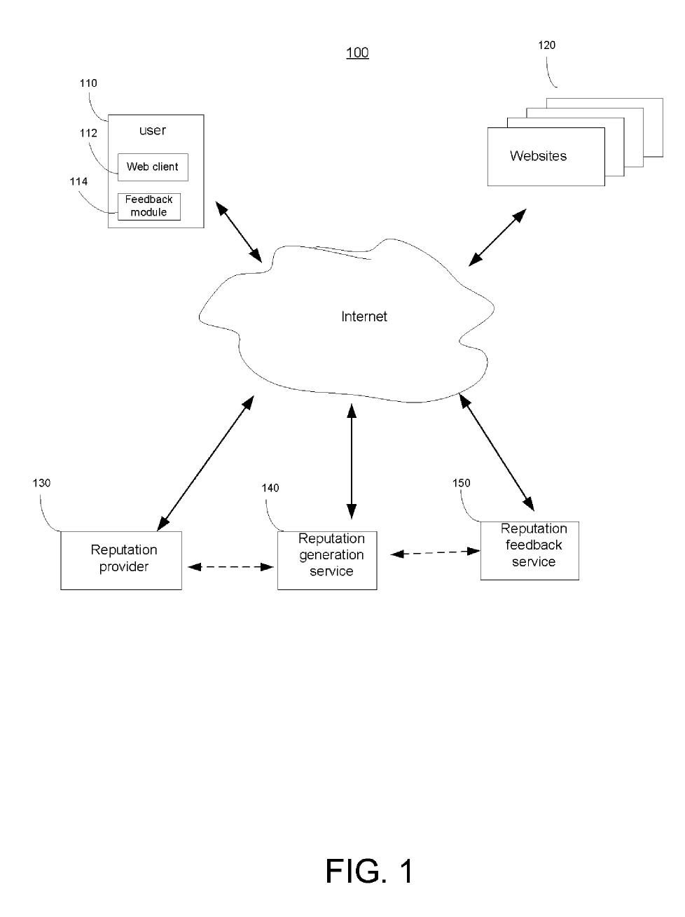

FIG. 1 shows a diagram of an exemplary system 100 for a feedback augmented object reputation service in accordance with one embodiment. As depicted in FIG. 1, the system 100 depicts a user 110 and a plurality of web sites 120 coupled to the Internet. A reputation provider 130, reputation generation service 140, and a reputation feedback service 150 are also coupled to the Internet as shown.

The system 100 embodiment implements a feedback augmented object reputation service. The reputation service is provided to the user 110 by the reputation provider 130. The user 110 accesses the Web sites 120, and through the course of such access typically encounters a number of software-based objects. The authenticity and/or the safety of these objects can be checked by interaction between the user 110 and the reputation provider 130.

In a typical usage scenario, the Web client 112 of the user 110 transmits reputation queries regarding one or more of the objects encountered on one or more of the web sites 120. The reputation provider 130 returns a object reputation corresponding to the query. This object reputation includes attributes that describe the authenticity, safety, reliability, or other such characteristics related to the object. In general, the object reputation describes a degree to which a given object can be characterized as being a dangerous object or a safe object. For example, the object reputation output can inform the user whether a particular link or URL provided by one of the web sites 120 is true (e.g., a phishing site, etc.) or false (e.g., the site is in fact authentic). This information can be visually provided to the user via GUI elements of the interface of the Web client 112.

The reputation provider 130 stores reputation information for the large number of objects that can be encountered by the user 110. For example, the reputation provider 130 can include a knowledgebase of the objects hosted by the web sites 120 and have a corresponding reputation value stored for each of these objects. The reputation generation service 140 functions by generating per object reputation and providing that reputation to the reputation provider 130. The reputation generation service 140 can utilize a number of different techniques to derive reputation attributes regarding a given object. Such techniques include, for example, machine learning algorithms, contextual filtering algorithms, object historical data, and the like.

The reputation feedback service 150 functions by receiving user feedback (e.g., from the user 110) and associating that feedback with the corresponding object. An objective of the feedback service is to obtain per object user feedback regarding attributes descriptive of the object (e.g., authenticity, safety, reliability, or other such characteristics) and transmit this information to the reputation generation service 140. This enables the reputation generation service 140 to update the reputation value for the objects in consideration of the received user feedback. In general, the solicitation of feedback from the user is triggered when the value for a given object reputation indicates the object is a potentially a dangerous object. The solicitation of feedback from the user is not triggered when the object reputation indicates the object is a safe object. The updating in consideration of the received feedback increases the accuracy and reliability of the per object reputation generated and transmitted to the reputation provider 130. In one embodiment, a feedback module 114 is included and is specifically configured to interface with the user and obtain the per object user feedback. The feedback module 114 then transmits the per object user feedback to the reputation feedback service 150.

In this manner, the feedback enabled updating of the reputation knowledgebase yields a number of advantages. For example, one advantage is the fact that the feedback enabled updating reduces the chances of a runaway increase in the number of false positives produced (e.g., safe objects that are incorrectly classified as dangerous objects). The feedback mechanism will quickly identify those objects which may be mistakenly labeled as dangerous objects (e.g., malware false-positive), while simultaneously increasing the heuristic true-positive rate.

Another advantage is the fact that the feedback enabled updating utilizes a community to provide judgment on objects. The community can use information to derive an initial reputation from any source or update existing reputation (e.g., personal knowledge, etc.), as opposed to merely the static client code, or object code, or the like. Another advantage is the fact that community feedback enabled updating alleviates the dependency on one or more centralized grading staffs (e.g., at a mail client vendor, webmail provider, etc.) to assess and correctly decide medium confidence reputation scenarios. The community feedback mechanism can leverage the broad user base to improve the experience for the community as a whole.

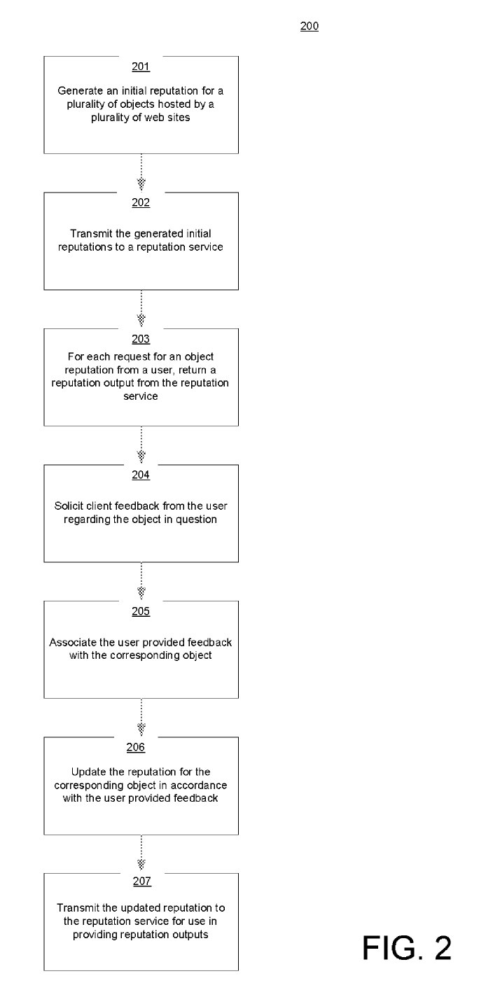

FIG. 2 shows a flowchart of the steps of a feedback augmented object reputation process 200 in accordance with one embodiment. As depicted in FIG. 2, process 200 shows the exemplary steps that are executed to generate initial reputation data to populate a reputation knowledgebase, obtain client feedback regarding objects encountered during use, and update the reputation knowledgebase to increase accuracy and usability. The system 100 functionality will now be described with reference to process 200 of FIG. 2.

Process 200 begins at step 201, where an initial reputation is generated for a plurality of objects hosted by the plurality of web sites 120. As described above, the reputation generation service 140 utilizes a number of different techniques to derive reputation attributes regarding a given object (e.g., machine learning algorithms, object historical data, etc.). At step 202, the generated initial reputations are transmitted to the reputation provider 130. The initial reputations are used to populate the reputation knowledgebase and provide a level of service upon which subsequent arriving reputation feedback can improve.

At step 203, the reputation provider 130 receives reputation queries from the user 110. As described above, as each user requests reputation information regarding one or more objects, the reputation provider will return a reputation output for that object. At first, the object reputation output will be based upon the initial reputation information generated at step 201. At step 204, as the object reputation output has been transmitted to the user, the feedback module 114 can solicit user feedback regarding the particular object in question. In general, the solicitation of feedback from the user is triggered when the value for the object reputation indicates the object is potentially a dangerous object, and the solicitation of feedback from the user is not triggered when the value for the object reputation indicates the object is a safe object. As described above, the user feedback can include a number of different attributes descriptive of the object (e.g., authenticity, safety, reliability, or other such characteristics). The user's feedback can be conclusive with regard to whether they think the object is a positive (e.g., malware, phishing site, etc.) or a negative tag (e.g., authentic, safe, etc.). Conjointly or alternatively, the determination can be biased toward safety for those objects where the reputation is unclear. For example, those objects having a reputation that is not sufficient to label them “safe” can be treated such that they will trigger the feedback solicitation process.

At step 205, the user provided feedback is associated with the corresponding object by the reputation feedback service 150. At step 206, the reputation generation service updates its reputation generation mechanisms in consideration of the user provided feedback. Then in step 207, the updated reputation for the object is transmitted to the reputation provider 130, which in turn updates its reputation knowledgebase. In this manner, the accuracy and usability of the reputation knowledgebase is quickly improved in consideration of the feedback obtained from actual users.

It should be noted that additional information (e.g., in addition to the yes/no response) is included in the feedback received from the user, this information is used in the reputation generation process. Such additional information includes, for example, metadata describing the object in question, information identifying the user, and the like. Additionally, the historical performance of the particular user providing the feedback can be taken into consideration. For example, those users with a strong history of accurately identifying dangerous objects can be given a stronger weighting. Similarly, those users with a history of inaccurate object feedback (e.g., high false positive rate) can be given a reduced weighting. In some cases, such additional information may be more powerful in the reputation generation process than the yes/no feedback response.

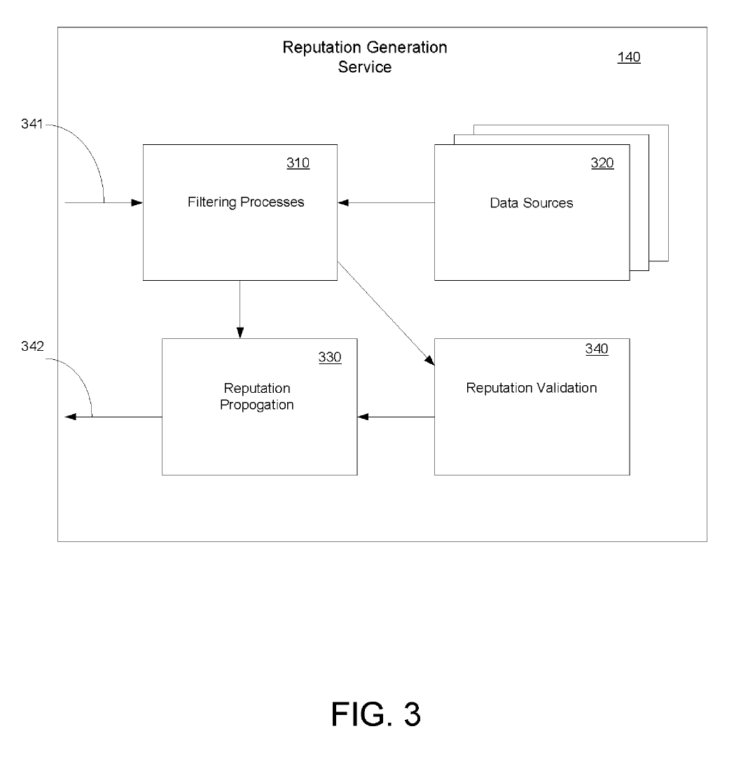

FIG. 3 shows a diagram of internal components of the reputation generation service 140 in accordance one embodiment. As depicted in FIG. 3, the reputation generation service 140 includes a filtering process component 310, a plurality of data sources 320, a reputation propagation component 330, and a reputation validation component 340.

In the FIG. 3 embodiment, the filtering process component 310 is coupled to receive reputation feedback information from the reputation feedback service 150 (e.g., shown in FIG. 1) as indicated by the line 341. The reputation propagation component 330 is coupled to transmit reputation information to the reputation provider 130 (e.g., a shown in FIG. 1) as indicated by the line 342.

An exemplary usage scenario is now described. In this scenario, it is assumed that a URL (e.g., foo.com, etc.) has arrived and populates one or more of the source data components 320. The source data components 320 comprise modules that interface with different service provider agents (e.g., e-mail providers, e-mail clients, external heuristic engines, and the like) and can identify objects of interest. The filtering algorithms of the filtering component 310 receives the object and yields an inconclusive reputation rating for the URL, but it is assumed that the component 310 is inclined to tag the URL toward the dangerous end of the spectrum. An appropriate reputation message (e.g., “Is this phish?”) is then propagated to the reputation provider 130 regarding the URL. At this point, a user (e.g., user 110 of FIG. 1) navigates to the URL (e.g., foo.com) and the reputation request is made to the reputation provider 130. The reputation service provider 130 returns the “is this phish?” reputation value. The user's Web browser then invokes the “is this phish?” user experience via the feedback module 114. The user responds to the call to action by indicating the site is in fact phishing. The user response, user ID and site meta data are subsequently transmitted back to the reputation feedback service 150, as described above. This updated information is then used to update the plurality of data sources 320. In this manner, as described above, the accuracy and usability of the reputation knowledgebase is improved by the feedback obtained from the user.

Referring still to FIG. 3, the data source 320 can include source data collection and storage databases, community feedback reports, heuristic logging reports, webmail generated community reports, webmail message mining data, “Is this phish?” community reports, and the like. The filtering process in 310 can include algorithms such as machine learning filters, meta service functions, historical and contextual filtering functions, user reputation functions, and the like.

The reputation propagation component 330 can include functionality that implements the management of filter output from the filter component 310 (e.g., block ratings, “Is this phish” rating, Junk, etc.). The reputation propagation component 330 can also include functionality for false positive mitigation, rollup and inheritance management, and specific time-to-live settings for “is this phish” ratings (e.g., expires after 36 hrs, etc.).

The reputation validation component 340 can include functionality that validates whether or not objects that are labeled as dangerous actually are dangerous. The validation component 340 can also include functionality for false positive mitigation.

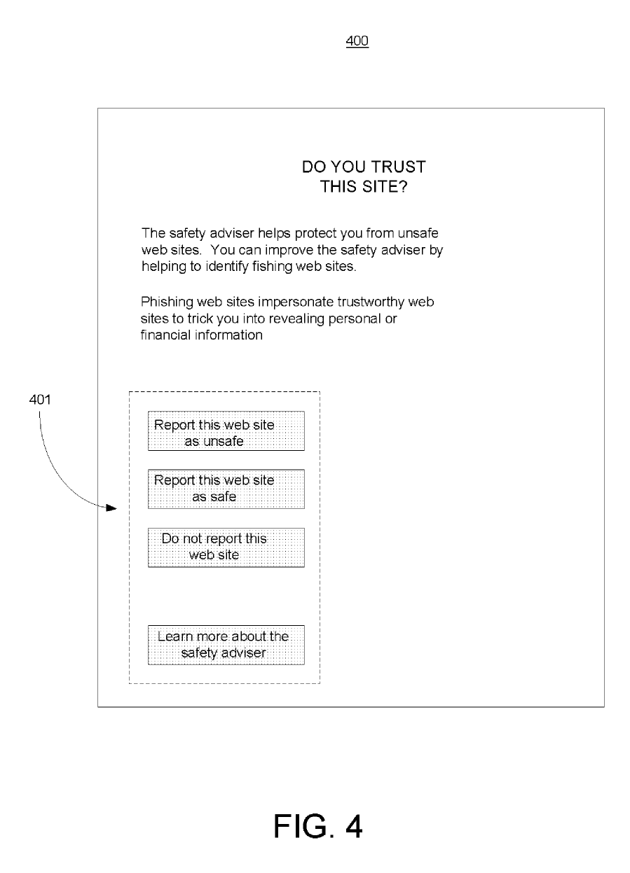

FIG. 4 shows an exemplary user feedback prompt dialog 400 in accordance with one embodiment. The dialogue 400 shows one example of a user interface prompt that can be provided to the user via, for example, a Web browser interface. As described above, the dialogue 400 would be triggered by the return of reputation information indicating an object is likely a dangerous object. The dialogue provides the user information regarding the safety of the site, and prompts the user to provide feedback. The dialogue 400 further includes interface elements 401 (e.g., buttons, icons, etc.) to enable the user to provide the feedback, and possibly other interface elements for example, to learn more about the functionality of the feedback service or, learn more about how to provide educated feedback (e.g., “learn more about the safety adviser, learn more about identifying phishing”). Thus, when the user clicks on a selected one of the elements 401, that response and its associated key meta data is transmitted back to the reputation feedback service (e.g., reputation feedback service 150).

FIG. 5 shows an exemplary computer system 500 according to one embodiment. Computer system 500 depicts the components of a basic computer system providing the execution environment for certain hardware-based and software-based functionality for the above described embodiments. For example, computer system 500 can be a system upon which the components 130-150 from FIG. 1 are instantiated. Computer system 500 can be implemented as, for example, a desktop computer system, laptop computer system or server computer system. Similarly, computer system 500 can be implemented as a handheld device. Computer system 500 typically includes at least some form of computer readable media. Computer readable media can be a number of different types of available media that can be accessed by computer system 500 and can include, but is not limited to, computer storage media.

In its most basic configuration, computer system 500 typically includes processing unit 503 and memory 501. Depending on the exact configuration and type of computer system 500 that is used, memory 501 can be volatile (e.g., such as DRAM, etc.) 501a, non-volatile 501b (e.g., such as ROM, flash memory, etc.) or some combination of the two.

Additionally, computer system 500 can include mass storage systems (e.g., removable 505 and/or non-removable 507) such as magnetic or optical disks or tape. Similarly, computer system 500 can include input devices 509 and/or output devices 511 (e.g., such as a display). Computer system 500 can further include network connections 513 to other devices, computers, networks, servers, etc. using either wired or wireless media. As all of these devices are well known in the art, they need not be discussed in detail.

The FIG. 5 embodiment shows the reputation provider 130, the reputation generation service 140, and the reputation feedback service 150 instantiated in the system memory 501. The components 130, 140, and 150 generally comprise computer executable instructions that can be implemented as program modules, routines, programs, objects, components, data structures, or the like, to perform particular tasks or implement particular abstract data types. The computer system 500 is one example of a suitable operating environment. A number of different operating environments can be utilized to implement the functionality of the feedback augmented object reputation service. Such operating environments include, for example, personal computers, server computer systems, multiprocessor systems, microprocessor based systems, minicomputers, distributed computing environments, and the like, and the functionality of the components 130, 140, and 150 may be combined or distributed as desired in the various embodiments.

The foregoing descriptions of the embodiments have been presented for purposes of illustration and description. They are not intended to be exhaustive or to limit the claimed subject matter to the precise forms disclosed, and many modifications and variations are possible in light of the above teaching. The embodiments were chosen and described in order to best explain the principles and practical applications of the embodiments, to thereby enable others skilled in the art to best utilize the invention and various embodiments with various modifications as are suited to the particular use contemplated. It is intended that the scope of the claimed subject matter be defined by the claims appended hereto and their equivalents.

What is claimed is:

1. A method for a feedback augmented object reputation service, comprising:
receiving a request for an object reputation from a user;
in response to the request, accessing a reputation generation service to determine a value for the object reputation;
returning the value for the object reputation to the user;
soliciting feedback from the user when displaying information regarding the object reputation;
receiving feedback regarding the returned object reputation from the user; and
updating a knowledge base describing the object reputation in consideration of the feedback, and returning an updated object reputation in response to a subsequent request.

2. The method of claim 1, further comprising:
generating an initial reputation for the object and using the initial reputation to determine the value for the object reputation; and
updating the knowledge base describing the initial object reputation in accordance with the feedback.

3. The method of claim 2, wherein the initial reputation for the object is obtained from a plurality of sources descriptive of the object.

4. The method of claim 1, wherein the soliciting of feedback from the user is implemented by a feedback module functioning with graphical user interface of a Web client of the user.

5. The method of claim 1, wherein the object reputation describes a degree to which the object can be characterized as being a dangerous object or a safe object.

6. The method of claim 5, wherein the solicitation of feedback from the user is triggered when the value for the object reputation indicates the object is potentially dangerous, and the solicitation of feedback from the user is not triggered when the value for the object reputation indicates the object is safe.

7. The method of claim 1, wherein the knowledge base is configured to incorporate feedback from a plurality of users regarding a plurality of corresponding objects to increase a dangerous object identification accuracy.

8. A method for utilizing feedback to implement an object reputation service, comprising:
receiving a plurality of requests for object reputation for a plurality of objects from a plurality of users;
in response to the requests, generating respective initial object reputations and returning the initial object reputations to the users;
for those objects having a reputation indicating malware, soliciting feedback from the users for information regarding the objects;
receiving the solicited feedback; and
updating a knowledge base describing the object reputation in consideration of the solicited feedback; and
returning updated object reputations in response to a subsequent requests.

9. The method of claim 8, further comprising:
using a machine learning technique to generate the respective initial object reputations.

10. The method of claim 8, using contextual filtering to generate the respective initial object reputations.

11. The method of claim 8, wherein a performance history of a user is included in the updating of the knowledge base, and wherein the performance history describes accuracy of the user at identifying dangerous objects.

12. The method of claim 8, wherein at least one of the plurality of objects comprises a URL and an object reputation corresponding to the URL describes a degree to which the URL is a dangerous object.

13. The method of claim 8, further comprising:
specifying a time-to-live attribute for a reputation that indicates a dangerous object.

14. The method of claim 8, wherein the knowledge base is configured to incorporate the feedback to increase identification accuracy.

15. The method of claim 14, wherein the increased identification accuracy causes a reputation of one object to change from a dangerous object reputation to a safe object reputation, or causes the reputation of one object to change from a safe object reputation to a dangerous object reputation.

16. The method of claim 8, wherein the feedback received from the users further include metadata describing the plurality of objects.

17. A Web client comprising:
a web browser operative to access objects and to request reputation of said objects; and
a feedback module operative to solicit feedback concerning reputation of an object from a user if said reputation of the object indicates the object is a dangerous object.

18. The Web client of claim 17, wherein the feedback module displays a dialogue descriptive of the object and the reputation of the object to the user if the reputation of the object indicates the object is dangerous.

19. The Web client of claim 17, wherein the feedback module is inactive if the reputation of the object indicates the object is safe.

20. The Web client as recited in claim 17, wherein said web browser requests the reputation of the object from a reputation service.
